(19) United States
(12) Patent Application Publication
(10) Pub. No.: US 2024/0013061 A1
(43) Pub. Date: Jan. 11, 2024

(54) ARCHITECTURE SEARCH METHOD AND APPARATUS FOR LARGE-SCALE GRAPH, AND DEVICE AND STORAGE MEDIUM

(71) Applicant: Tsinghua University, Beijing (CN)

(72) Inventors: Wenwu ZHU, Beijing (CN); Xin WANG, Beijing (CN); Chaoyu GUAN, Beijing (CN); Hong CHEN, Beijing (CN)

(73) Assignee: Tsinghua University, Beijing (CN)

(21) Appl. No.: 18/093,826

(22) Filed: Jan. 6, 2023

(30) Foreign Application Priority Data
Jul. 7, 2022 (CN) 202210794670.X

(51) Int. Cl. G06N 3/092; G06N 3/04

(52) U.S. Cl. CPC G06N 3/092; G06N 3/04

(57) ABSTRACT

An architecture search method and an architecture search apparatus for a large-scale graph, and a device and a storage medium are provided. The method includes: obtaining a subgraph of a large-scale graph by performing local sampling on the large-scale graph; sampling a plurality of neural network architectures in a pre-constructed super network according to a pre-customized importance sampling strategy; obtaining a plurality of trained neural network architectures by training, according to a peer learning method, the plurality of neural network architectures with the subgraph; obtaining a trained super network by iteratively executing the subgraph sampling, the architecture sampling, and the architecture training; and selecting an optimal architecture in the trained super network to process the large-scale graph to obtain a graph processing result.

### CROSS-REFERENCE TO THE RELATED APPLICATIONS

This application is based upon and claims priority to Chinese Patent Application No. 202210794670.X, filed on Jul. 7, 2022, the entire contents of which are incorporated herein by reference.

### TECHNICAL FIELD

Embodiments of the present application relate to the technical field of graph data processing, and in particular, to an architecture search method and apparatus for large-scale graphs, and a device and a storage medium.

### BACKGROUND

Graph data is data of a graph structure composed of nodes and edges, such as social network relationship graph, protein molecular structure graph, and the like. A graph neural network is specially used for processing the graph data and achieving tasks corresponding to the graph data. Graph neural network architecture search means searching for a suitable neural network architecture according to different graph data tasks, and is a research hotspot nowadays. In particular, it is a problem to be solved that how to process large-scale graph data and search for a suitable architecture quickly. In the related art, the actual standard designs of neural networks mostly follow a message-passing framework. A graph sampling method is used for processing the large-scale graph data, that is, a partial graph is sampled from the large-scale graph, and the neural network is trained merely on the partial graph. In the graph neural network architecture search, an architecture search is first carried out with a small subgraph, then the architecture search is expanded to a medium-scale graph.

In the related art, the processing method for large graph data is useful merely in expanding and stabilizing the training of a single graph neural network, but fails to process or train a super network, and thus cannot perform architecture search. The search method with a small subgraph cannot deal with errors caused by the complexity of graph structure and the randomness of sampling, and cannot ensure that the searched architecture fits the original graph. Besides, the search method with a small subgraph has poor expansibility, and cannot handle adjustment and optimization of a graph neural network with a scale of hundreds of millions of nodes.

### SUMMARY

Embodiments of the present application provide an architecture search method and apparatus for a large-scale graph, and a device and a storage medium.

A first aspect of embodiments of the present application provides an architecture search method for a large-scale graph, including:
obtaining a subgraph of a large-scale graph by performing local sampling on the large-scale graph;
sampling a plurality of neural network architectures in a pre-constructed super network according to a pre-customized importance sampling strategy;
obtaining a plurality of trained neural network architectures by training, according to a peer learning method, the plurality of neural network architectures with the subgraph;
obtaining a trained super network by iteratively executing the subgraph sampling, the architecture sampling, and the architecture training; and
obtaining an optimal architecture corresponding to the large-scale graph by
performing architecture search on the super network.

In some embodiments, the obtaining a subgraph of a large-scale graph by performing local sampling on the large-scale graph includes:
determining a sampling area in the large-scale graph; and
obtaining the subgraph by sampling nodes and edges in the sampling area.

In some embodiments, the plurality of neural network architectures are randomly sampled in the pre-constructed super network according to the pre-customized importance sampling strategy, the importance sampling strategy is customized by:
agent decision-making for making, by an agent, a decision to determine a plurality of neural network architectures in the super network in the architecture sampling, and sampling the plurality of neural network architectures;
graph data processing for obtaining a graph data processing result by processing graph data through the plurality of neural network architectures;
reward value returning for returning a reward value to the agent based on an accuracy of the graph data processing result;
strategy adjusting for adjusting, based on the reward value, a strategy for a next sampling by the agent; and
obtaining a trained agent by iteratively executing the agent decision-making, the graph data processing, the reward value returning, and the strategy adjusting, where an architecture sampling strategy executed by the agent is the importance sampling strategy.

In some embodiments, the super network includes all graph network layers, each including all information transport methods.

In some embodiments, the obtaining a plurality of trained neural network architectures by training, according to a peer learning method, the plurality of neural network architectures with the subgraph includes:
grouping the plurality of neural network architectures as a learning team;
selecting an optimal architecture from the learning team, and obtaining a
classification difficulty value of each of nodes in the subgraph by evaluating classification difficulty of each of the nodes through the optimal architecture;
setting a weight for a loss value of each of the nodes based on the classification difficulty value of each of the nodes; and
obtaining a plurality of trained neural network architectures by adjusting parameters of the plurality of neural network architectures based on the loss value.

In some embodiments, the selecting an optimal architecture from the learning team, and obtaining a classification difficulty value of each of nodes in the subgraph by evaluating classification difficulty of each of the nodes through the optimal architecture, includes:
obtaining node classification results corresponding to the plurality of neural networks by classifying the nodes of the subgraph through each neural network architecture in the plurality of neural network architectures;
performing accuracy statistics on the node classification results, and selecting a neural network architecture corresponding to the node classification result with the highest accuracy as the optimal architecture; and
obtaining the classification difficulty value of each of the nodes in the subgraph by evaluating classification difficulty of each of nodes based on the node classification result corresponding to the optimal architecture.

In some embodiments, the setting a weight for a loss value of each of the nodes based on the classification difficulty value of each of the nodes includes:
setting a low weight for the loss value of the node in response to determining that the classification difficulty value of the node is high; and
setting a high weight for the loss value of the node in response to determining that the classification difficulty value of the node is low.

A second aspect of embodiments of the present application provides an architecture search apparatus for a large-scale graph, including:
a subgraph sampling module, configured to obtain a subgraph of a large-scale graph by performing local sampling on the large-scale graph;
an architecture sampling module, configured to sample a plurality of neural network
architectures in a pre-constructed super network according to a pre-customized importance sampling strategy;
an architecture training module, configured to obtain a plurality of trained neural network architectures by training, according to a peer learning method, the plurality of neural network architectures with the subgraph;
a super network training module, configured to obtain a trained super network by iteratively executing operations of subgraph sampling, architecture sampling, and architecture training; and
an architecture search module, configured to obtain an optimal architecture corresponding to the large-scale graph by performing architecture search on the super network.

In some embodiments, the subgraph sampling module includes:
a sampling area determination sub-module, configured to determine a sampling area in the large-scale graph; and
a subgraph sampling sub-module, configured to obtain the subgraph by sampling nodes and edges in the sampling area.

In some embodiments, a plurality of neural network architectures are sampled randomly in a pre-constructed super network according to a pre-customized importance sampling strategy, the importance sampling strategy is customized through the following steps:
in architecture sampling, making, by an agent, a decision to determine a plurality of neural network architectures in the super network, and sampling the plurality of neural network architectures;
obtaining a graph data processing result by processing graph data through the plurality of neural network architectures;
returning a reward value to the agent based on the accuracy of the graph data processing result;
adjusting, based on the reward value, the strategy for a next sampling by the agent; and
obtaining a trained agent by iteratively executing the above steps of agent decision-making, graph data processing, reward value returning, and strategy adjusting, an architecture sampling strategy executed by the trained agent is the importance sampling strategy.

In some embodiments, the super network includes all graph network layers, each including all information transport methods.

In some embodiments, the architecture training module includes:
a learning team building sub-module, configured to group the plurality of neural network architectures as a learning team;
a classification difficulty value evaluation sub-module, configured to select an optimal architecture in the learning team, and obtain a classification difficulty value of each of the nodes in the subgraph by evaluating classification difficulty of each of nodes through the optimal architecture;
a weight setting sub-module, configured to set a weight for a loss value of each of the nodes based on the classification difficulty value of each of the nodes; and
a parameter adjustment sub-module, configured to obtain a plurality of trained neural network architectures by adjusting parameters of the plurality of neural network architectures based on the loss value.

In some embodiments, the classification difficulty value evaluation sub-module includes:
a classification result acquisition sub-module, configured to obtain node classification results corresponding to the plurality of neural networks by classifying the nodes of the subgraph through each neural network architecture in the plurality of neural network architectures;
an optimal architecture acquisition sub-module, configured to perform accuracy statistics on the node classification results, and select a neural network architecture corresponding to the node classification result with the highest accuracy as the optimal architecture; and
a classification difficulty value determination sub-module, configured to obtain a classification difficulty value of each of the nodes in the subgraph by evaluating classification difficulty of each of nodes based on the node classification result corresponding to the optimal architecture.

In some embodiments, the weight setting sub-module includes:
a first loss value weight setting sub-module, configured to set a low weight for the loss value of the node in response to determining that the classification difficulty value of the node is high, and
a second loss value weight setting sub-module, configured to set a high weight for the loss value of the node in response to determining that the classification difficulty value of the node is low.

A third aspect of embodiments of the present application provides a readable storage medium storing a computer program that, when executed by a processor, implements the steps in the method of the first aspect of the present application.

A fourth aspect of embodiments of the present application provides an electronic device including a memory, a processor, and a computer program stored on the memory and executable on the processor, where the computer program, when executed by the processor, implements the steps of the method of the first aspect of the present application.

### BRIEF DESCRIPTION OF THE DRAWINGS

In order to illustrate more clearly the technical solutions of embodiments of the present application, a brief introduction will be given to the accompanying drawings required to be used in the description of the embodiments of the present application. Apparently, the drawings in the description below are merely some embodiments of the present application, and those skilled in the art can obtain other drawings according to these drawings without involving any inventive effort.

FIG. 1 is a flowchart of an architecture search method for a large-scale graph according to an embodiment of the present application;

FIG. 2 is a schematic diagram illustrating a super network optimization flow according to an embodiment of the present application; and

FIG. 3 is a schematic diagram illustrating an architecture search apparatus for a large-scale graph according to an embodiment of the present application.

### DETAILED DESCRIPTION OF THE EMBODIMENTS

The technical solutions of the embodiments of the present application will now be described more clearly and fully hereinafter with reference to the accompanying drawings in the embodiments of the present application. Apparently, the embodiments described are only a few, but not all embodiments of the application. Based on the embodiments of the present application, all other embodiments obtained by those skilled in the art without involving inventive effort shall fall within the protection scope of the present application.

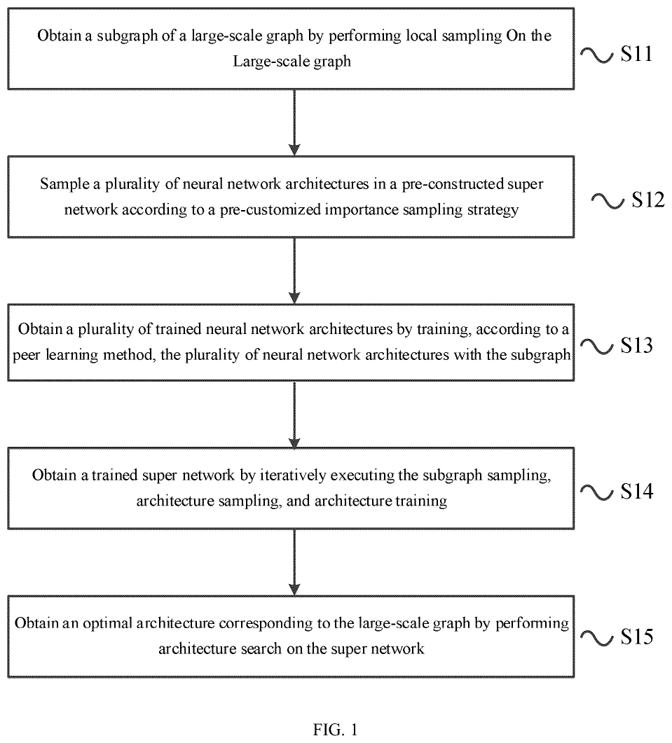

Reference is made to FIG. 1, which is a flowchart of an architecture search method for a large-scale graph according to an embodiment of the present application. As shown in FIG. 1, the method includes steps described below.

At S11, a subgraph of a large-scale graph is obtained by performing local sampling on the large-scale graph.

In the embodiment, the structure of a graph is composed of nodes and edges, where a node represents an independent unit, and an edge between two nodes represents a relationship between the nodes. A large-scale graph is composed of a large number of nodes and edges, and a subgraph can be formed by nodes and edges extracted from a partial area in the large-scale graph. The large-scale graph can be divided into a plurality of subgraphs, each being composed of nodes and edges of a continuous area in the large-scale graph.

In the embodiment, the large-scale graph needs to be locally sampled first, which means to extract nodes and edges between the nodes in a partial area of the large-scale graph, so as to obtain a subgraph of the large-scale graph.

In the embodiment, the step that the subgraph of the large-scale graph is obtained by performing local sampling on the large-scale graph includes the following specific steps.

At S11-1, a sampling area is determined in the large-scale graph.

At S11-2, nodes and edges in the sampling area are sampled to obtain the subgraph.

In the embodiment, when performing sampling on the graph, a sampling area is determined randomly in the large-scale graph, and nodes and edges in the sampling area are sampled to obtain a subgraph which is a part of the large-scale graph.

As an example, the sampling may be random sampling, for example a node is randomly selected in the large-scale graph and considered as a central node, which, together with nodes and edges within a certain range of its periphery (for example, within a radius of cm), is taken as a target sampling area, and the target sampling area is sampled to obtain a subgraph. Moreover, the number of nodes to be collected can be preset, for example, the number of nodes to be collected is preset to be 100. In this case, a node is randomly selected and considered as a center, neighbor nodes (and neighbor nodes thereof) of the node are sampled one by one, until 100 nodes are collected, and then the collection is stopped and a collected subgraph is obtained. The large-scale graph may be a relationship graph of all residents in a city, a relationship graph of historical figures and events in a period, an internal relationship graph of a complex structure, and the like.

At S12, a plurality of neural network architectures are obtained by sampling in a pre-constructed super network according to a pre-customized importance sampling strategy.

In the embodiment, the importance sampling strategy is an architecture sampling strategy for preliminarily predicting a neural network architecture that is most suitable for the input large-scale graph data. A super network is a search space including all possible network architectures, and is divided into a plurality of layers, each containing all information transport methods.

In the embodiment, after a subgraph sampling is completed, it is necessary to perform an architecture sampling in a pre-constructed super network according to a pre-customized importance sampling strategy to obtain a plurality of neural network architectures. When being constructed, the super network is abstracted into a series of information transport layers, and each of the layers can select a different information transport mechanism to construct the network. In the architecture sampling, an architecture with a higher accuracy of graph data processing has a greater probability of being collected. After the architecture sampling, a plurality of neural network architectures can be collected from the super network.

As an example, the architectures contained in the super network are all existing neural network architectures of Graph Convolutional Network (GCN) and Graph Attention Network (GAT). In the architecture sampling, a convolution operation is selected in a first layer, an attention operation is selected in a second layer, and a pooling operation is selected in a third layer, etc, thus a complete neural network architecture is formed by selecting a corresponding operation at each of the layers.

At S13, a peer learning method is used to train the plurality of neural network architectures with the subgraph, so as to obtain a plurality of trained neural network architectures.

In the embodiment, the peer learning method is a neural network architecture training method. Specifically, first, a plurality of neural network architectures are collected in a super network and these neural network architectures form a learning team, then a neural network architecture with the optimal performance is determined in the learning team, and the difficulty of each of nodes in the subgraph is estimated through the neural network architecture determined, meanwhile, a learning target for other network architectures in the learning team is determined by the neural network architecture determined.

In the embodiment, after the subgraph and the plurality of neural network architectures are collected, the peer learning method is used to determine a network architecture with the optimal performance in the plurality of neural network architectures. The network architecture determined is used to evaluate the difficulty of each of the nodes in the subgraph. An optimization target is determined for the whole learning team based on the difficulty of each of the nodes such that the neural network architectures in the learning team learn nodes with low difficulty first and then learn nodes with higher difficulty. When all the neural network architectures in the learning team are trained, the learning of the learning team is completed, and a plurality of trained neural network architectures are obtained.

As an example, 10 neural network architectures are obtained by sampling in the super network to form a learning team T, and Architecture 3 is determined as the architecture with the optimal performance. Each node in the graph is classified through Architecture 3. The difficulty of each node is determined according to the accuracy of the classification result, where the more accurate the classification result is, the lower difficulty the node has, and the larger the error between the classification result and a correct result node is, the higher difficulty the node has. After the difficulty of each of the nodes is determined, the remaining 9 neural network architectures are guided, based on the difficulty of the node determined by Architecture 3, to learn nodes with low difficulty first and then learn nodes with higher difficulty, and thereby completing the training of all neural network architectures in the learning team T.

At S14, a trained super network is obtained by iteratively executing the above steps of subgraph sampling, architecture sampling, and architecture training.

In the embodiment, for searching for a neural network architecture corresponding to the large-scale graph through the super network, the steps of subgraph sampling, architecture sampling, and architecture training need to be executed iteratively. A subgraph obtained by each sampling is only a partial area of the large-scale graph, and therefore the subgraph sampling and architecture sampling need to be repeated iteratively. When the sampling and training have been executed for a certain number of times, all the architectures in the super network will be optimized, and then a trained super network is obtained.

In the embodiment, when the sampling and training have been executed for a certain number of times, all the architectures in the super network tend to converge, and at this time, the parameters of all neural network architectures in the super network are adjusted to be optimal, after which the iteration process is stopped and a trained super network is obtained.

At S15, an optimal architecture corresponding to the large-scale graph is obtained by performing architecture search on the super network.

In the embodiment, the optimal architecture is an architecture in the super network through which each node in the input large-scale graph has the most accurate classification. The graph processing result is a processing result obtained by characterization extraction of the large-scale graph through the optimal architecture and according to a specific target task.

In the embodiment, after the trained super network is obtained, an optimal architecture is selected from the super network through a search algorithm to process the large-scale graph, where the search algorithm can be any commonly used search algorithm, such as an evolutionary algorithm or a genetic algorithm, which is not limited herein.

In another embodiment of the present application, after an optimal architecture is obtained, graph processing is performed on the large-scale graph through the optimal architecture to obtain a graph processing result.

In the embodiment, after the optimal architecture is obtained in the trained super network, the large-scale graph is input into the optimal architecture, and feature extraction is performed on the large-scale graph according to a target task input in advance to obtain a characterization vector of each of the nodes of the large-scale graph. The characterization vector, in combination with the relationships among the nodes, is used to predict the target task, so as to obtain a prediction result that is the processing result of the target task, namely, the graph processing result.

As an example, the large-scale graph is a character relationship graph, and the target task is to predict the favorite sport of each character. After an optimal architecture is selected in the super network, the character relationship graph is input into the optimal architecture to perform node characterization on the character relationship graph with the optimal architecture, and the favorite sport of the character corresponding to each node is predicted according to the node characterization of each node, so as to obtain the prediction result. In this way, the optimal architecture finishes the node classification task corresponding to the character relationship graph.

In the above embodiment, a super network is constructed based on one-shot strategy, in which a graph network is considered a series of information transport layers, and each of the layers can select a different information transport mechanism to construct the network. In the constructed super network, all the layers in the graph network are contained, each layer including all the information transport methods. Such a modeling method allows the super network to contain all possible networks in the search space, and any network in the space can be constructed only by activating the information transport method corresponding to the layer in the super network. During training, Monte Carlo Sampling is adopted to optimize the weight of the super network, a part of the large-scale graph is collected to limit the message flow, neural network architectures are collected through an importance strategy, the neural network architectures are trained by a peer learning method, and the whole super network is optimized by gradient descent. The method adopts joint architecture-subgraph sampling learning, and can smooth the highly non-convex optimization objectives, stabilize the architecture sampling process, reduce computational burden, and solve the problem of consistency collapse. In actual processing, the super network in the embodiment is empirically evaluated on five data sets with the number of vertex ranging from 10\hat{ }4 to 10\hat{ }8. The results show that the method provided in the embodiment is greatly superior to the existing methods for neural network architecture search in architecture search for a large-scale graph, and the method can complete neural network architecture search for a large-scale graph composed of billions of edges in a short time.

In another embodiment of the present application, the importance sampling strategy is customized through steps described below.

At S21, in the architecture sampling, a decision is made by an agent to determine a plurality of neural network architectures in the super network, and the plurality of neural network architectures are collected.

In the embodiment, an agent is an individual for decision-making that decides which information transport method is selected at which layer of the super network.

In the embodiment, a reinforcement learning method is used, and decisions are made by the agent to set a reward value as the accuracy of graph data processing, so that the importance sampling probability of the architectures can be well estimated.

At S22, a graph data processing result is obtained by processing graph data through the plurality of neural network architectures.

At S23, a reward value is returned to the agent based on the accuracy of the graph data processing result.

At S24, the strategy of the next sampling is adjusted by the agent based on the reward value.

In the embodiment, the reward value is a mechanism for rewarding the decision of the agent. When the decision of the agent has a positive effect, the reward value returned is positive, and when the decision of the agent has a negative effect, the reward value returned is little or negative.

In the embodiment, the graph data is processed using the neural network architecture selected by the agent, and a corresponding reward value is returned to the agent based on the processing result of the graph data. Upon receiving the reward value, the agent judges whether the decision has been made correctly based on the reward value, thereby adjusting the strategy for a next decision-making. A correct result of the target task has been pre-marked for the input graph data. By comparing the result predicted through the architecture with the correct result of the target task, a corresponding reward value is returned to the agent based on the similarity between the result predicted through the architecture and the correct result.

As an example, an Architecture A is selected and collected from the super network by an agent, and is then used to process the graph data. Assuming the target task is node classification of the graph data, the Architecture A performs node classification on the graph data to obtain a class of each of the nodes, and the obtained class of each of the nodes is compared with a pre-marked node class. A corresponding reward value is returned to the agent based on the comparison result, and the agent adjusts decision-making based on the reward value.

At S25, a trained agent is obtained by iteratively executing the above steps of making decisions by the agent, processing the graph data, returning the reward value, and adjusting the strategy, and an architecture sampling strategy executed by the trained agent is the importance sampling strategy.

In the embodiment, the steps of making decisions by the agent, processing the graph data, returning the reward value, and adjusting the strategy are iteratively executed. When the decision of the agent reaches an optimum, the iteration is ended and a trained agent is obtained. At this time, the strategy executed by the agent is the importance sampling strategy.

Even with a smooth optimization objective, the training process will still suffer instability issues caused by sampling the learning team in A˜N. In order to stabilize the training of a super network on a large-scale graph, importance sampling is provided to reduce the optimization variance. In terms of optimizing the weight of the super network, in order to avoid over-fitting, attention should be paid to the average accuracy over the validation data sets, and a stable estimation of the average accuracy of the validation data sets should be ensured to the largest extent. As known from an importance sampling formula, the possibility that an architecture is selected should be proportional to its accuracy when the accuracy estimation is best (when the variance is minimum). In a general case, all the architectures in the space need to be traversed, which is time-consuming.

Thus, in the embodiment, a reinforcement learning strategy is employed to estimate an optimal distribution of the architectures. By setting the accuracy of graph data processing through architectures as the reward for reinforcement learning, the importance sampling probability of the architectures can be well estimated.

In another embodiment of the present application, the step, in which a peer learning method is used to train the plurality of neural network architectures with the subgraph to obtain a plurality of trained neural network architectures, includes steps described below.

At S31, the plurality of neural network architectures are grouped as a learning team.

In the embodiment, the peer learning method is used, the collected plurality of neural network architectures are grouped as a learning team, and the plurality of neural network architectures in the learning team have a common optimization objective.

At S32, an optimal architecture is selected from the learning team, and classification difficulty of each of nodes in the subgraph is evaluated through the optimal architecture to obtain a classification difficulty value of each of the nodes.

In the embodiment, the classification difficulty value of a node represents a difficulty level of accurately classifying the node.

In the embodiment, it is necessary to select an optimal architecture from the learning team, and evaluate classification difficulty of each of nodes in the subgraph through the optimal architecture to obtain a classification difficulty value of each of the nodes.

In the embodiment, the step, in which an optimal architecture is selected from the learning team, and classification difficulty of each of nodes in the subgraph is evaluated through the optimal architecture to obtain a classification difficulty value of each of the nodes, includes the following specific steps.

At S32-1, node classification results corresponding to the plurality of neural network architectures are obtained by classifying nodes of the subgraph through each neural network architecture in the plurality of neural network architectures.

At S32-2, accuracy statistics is performed on the node classification results, and a neural network architecture corresponding to the node classification result with the highest accuracy is selected as the optimal architecture.

In the embodiment, the nodes of the collected subgraph are classified through each neural network architecture in the plurality of neural network architectures, thus a node classification result will be obtained for each neural network architecture. Since classes of the nodes in the subgraph are pre-marked, the accuracy of node classification through the neural network architectures can be counted. The neural network architecture corresponding to the node classification result with the highest accuracy among the plurality of node classification results is determined to be the optimal architecture.

As an example, there are 10 architectures in the learning team. By classifying nodes in the subgraph through these 10 architectures, node classification results are obtained. Accuracy statistics is performed on the node classification results, and it is found that the accuracy of Architecture 3 is the highest, and then Architecture 3 is the optimal architecture.

At S32-3, a classification difficulty value of each of the nodes in the subgraph is obtained by evaluating, based on the node classification result corresponding to the optimal architecture, classification difficulty of each of the nodes.

In the embodiment, classification difficulty value of each of the nodes in the subgraph is obtained by evaluating, based on the node classification result corresponding to the optimal architecture, classification difficulty of each of the nodes. The node classification result of the optimal architecture is compared with the correct result which is pre-marked to obtain a classification difficulty value of each of the nodes. In the embodiment, the closer the distance between the vector of the node classification result and the vector of the correct result is, the lower the classification difficulty value of the node is, and the farther the distance between the vector of the node classification result and the vector of the correct result is, the higher the classification difficulty value of the node is.

As an example, the graph data is a character relationship graph, the node classification task is classification in terms of age, and the classification result includes children, adolescents, youth, middle-aged people, and old people. If the classification result of node A through the optimal architecture is children and the actual result is adolescents, then the classification is wrong, and the classification difficulty value of node A is high. If the classification result of node B through the optimal architecture is old people and the actual result is also old people, then the classification is correct, and the classification difficulty value of node B is low.

It will be memory-consuming for a large-scale graph if all computation graphs of a plurality of sampled neural network architectures are stored. In order to reduce complexity, the embodiment provides a strategy of dynamically recording difficulty estimation of the current optimal architecture. That is, only the node classification difficulty value of the current optimal architecture is recorded.

As an example, there are 10 architectures in the learning team. The node difficulty value obtained by Architecture 1 is first recorded, and when the classification effect of Architecture 2 is better than that of Architecture 1, the node difficulty value recorded for Architecture 1 is deleted, and only the node difficulty value obtained by Architecture 2 is recorded, and so on, so as to dynamically record the node difficulty value obtained by the architecture with the best classification effect among the 10 architectures.

At S33, a weight for a loss value of each of the nodes is set based on the classification difficulty value of each of the nodes.

In the embodiment, the step, in which a weight for a loss value of each of the nodes is set based on the classification difficulty value of each of the nodes, includes the following steps.

At S33-1, a low weight is set for the loss value of the node in response to determining that the classification difficulty value of the node is high.

At S33-2, a high weight is set for the loss value of the node in response to determining that the classification difficulty value of the node is low.

In the embodiment, when the sampled neural network architecture is trained, parameters of the whole neural network architecture are adjusted by the loss value of each of the nodes. A high node classification difficulty indicates that even the optimal architecture fails to accurately classify the node, and at this time, a low weight is set for the loss value of the node. When the parameters of the neural network are adjusted, the adjustment of the parameters of the neural network due to the loss value of the node is small. A high weight is set for the loss value of the node when the classification difficulty of the node is low, and the adjustment of the parameters of the neural network due to the loss value of the node is greater. In order to finally complete the optimization of the loss of each of the nodes, the loss weights for all points will eventually approach 1.

At S34, a plurality of trained neural network architectures are obtained by adjusting parameters of the plurality of neural network architectures based on the loss value.

In the embodiment, a parameter adjustment is performed, based on the loss value of each of the nodes on each subgraph, on each neural network architecture via a loss function. When the neural network architecture tends to converge, the parameter is adjusted to be optimal, and a plurality of trained neural network architectures are obtained.

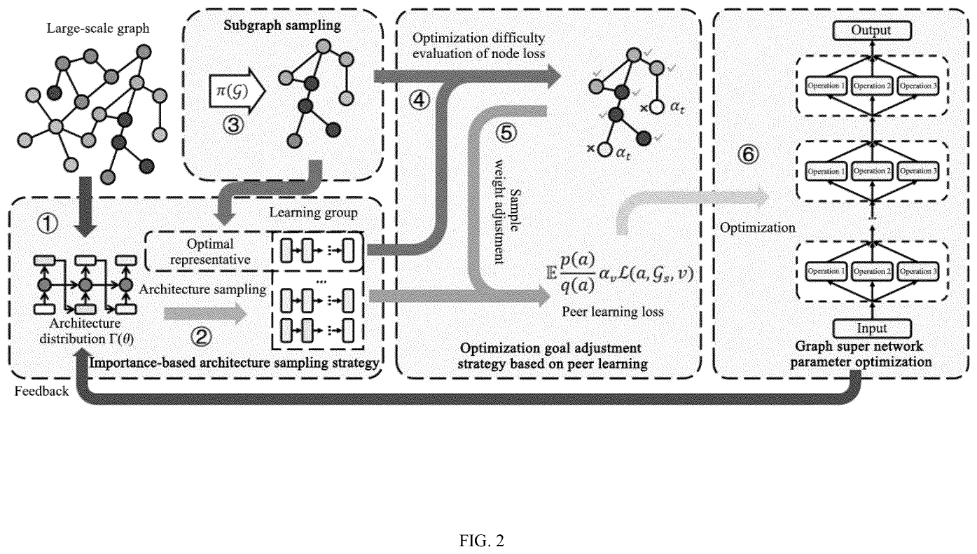

Reference is made to FIG. 2, which is a schematic diagram illustrating a super network optimization flow according to an embodiment of the present application, and the embodiment of the present application is further described below in conjunction with FIG. 2. As shown in FIG. 2, a subgraph sampling is first performed on a large-scale graph to obtain a subgraph of the large-scale graph. Meanwhile, an optimal architecture distribution is preliminarily selected by using an importance-based architecture sampling strategy, and a plurality of neural network architectures are collected to form a corresponding learning group (a learning team), where π(g) represents the subgraph. Then an optimization difficulty of node loss is evaluated through an optimization objective adjustment strategy based on peer learning, to find an optimal architecture. The weight for loss value of each node is adjusted based on the node optimization difficulty, namely, the node classification difficulty, obtained through the optimal architecture. In the peer learning loss formula, IE represents expectation, P(a) represents uniform distribution, q(a) represents reinforcement distribution, αᵥ represents the weight of the node, a represents the architecture, g s represents the subgraph, v represents the node, and L(a, gₛ,v) represents the loss value of node v on the architecture a. When the parameters of the neural network architectures are optimized, the parameters of the super network are optimized by using the loss function, where operations 1, 2 and 3 of the layers in the super network represent different information transport methods.

According to the embodiments of the present application, the expansibility of the current graph neural network search methods is greatly improved, even for a large-scale graph (with a scale of hundreds of millions of nodes), the adjustment and optimization of a graph neural network can be completed in one day. The effect on unknown large-scale data tasks can be greatly enhanced, and an optimal network architecture to process unknown large-scale data sets can be found in a short time by means of automatically adjusting model designs by machine, which greatly saves computing resources and computing time, and the large-scale graph structure data can be processed quickly and accurately.

The architecture search method for a large-scale graph provided by the present application includes: obtaining a subgraph of the large-scale graph by performing local sampling on the large-scale graph; sampling a plurality of neural network architectures in a pre-constructed super network according to a pre-customized importance sampling strategy; obtaining a plurality of trained neural network architectures by training, according to a peer learning method, the plurality of neural network architectures with the subgraph; obtaining a trained super network by iteratively executing the above steps of subgraph sampling, architecture sampling, and architecture training; obtaining an optimal architecture corresponding to the large-scale graph by performing architecture search on the super network. In the present application, a large-scale graph is locally sampled and a plurality of neural networks are sampled in a super network according to an importance sampling strategy, so that a preliminary evaluation can be made on the accuracy of the neural network architectures, ensuring that the selected plurality of neural network architectures have a certain accuracy and reducing the difficulty of training; then the plurality of neural networks are trained with the subgraph according to a peer learning method, which may allow the architectures to help each other and find the most suitable optimization objective, so that a learning process of the architectures is smooth, thus completing the training of the super network more conveniently and quickly. Further, when the large-scale graph data is processed, the neural network architecture corresponding to the graph data can be found quickly, and thus the processing of the large-scale graph data can be completed quickly.

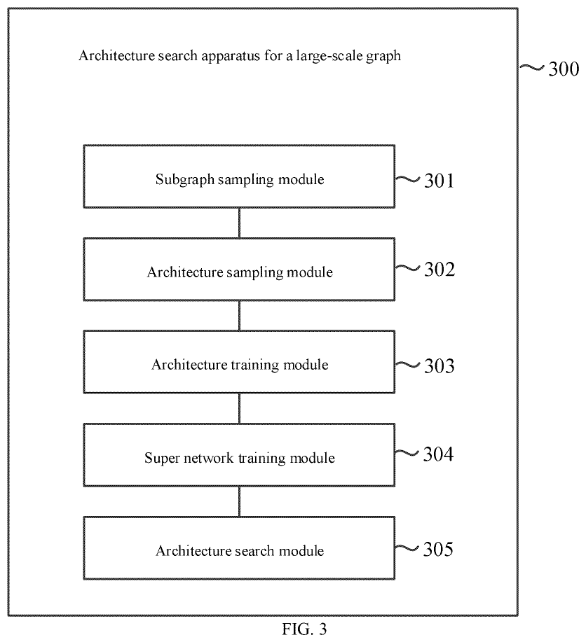

Based on the same inventive concept, an embodiment of the present application provides an architecture search apparatus for a large-scale graph. Reference is made to FIG. 3, which is a schematic diagram illustrating an architecture search apparatus 300 for a large-scale graph according to an embodiment of the present application. As shown in FIG. 3, the apparatus includes a subgraph sampling module 301, an architecture sampling module 302, an architecture training module 303, a super network training module 304 and an architecture search module 305.

The subgraph sampling module 301 is configured to obtain a subgraph of the large-scale graph by performing local sampling on the large-scale graph.

The architecture sampling module 302 is configured to obtain a plurality of neural network architectures by sampling in a pre-constructed super network according to a pre-customized importance sampling strategy.

The architecture training module 303 is configured to obtain a plurality of trained neural network architectures by training, according to a peer learning method, the plurality of neural network architectures with the subgraph.

The super network training module 304 is configured to obtain a trained super network based on iterations operations of subgraph sampling, architecture sampling, and architecture training of the above modules.

The architecture search module 305 is configured to obtain an optimal architecture corresponding to the large-scale graph by performing architecture search on the super network.

In some embodiments, the subgraph sampling module includes a sampling area determination sub-module and a subgraph sampling sub-module.

The sampling area determination sub-module is configured to determine a sampling area in the large-scale graph.

The subgraph sampling sub-module is configured to obtain the subgraph by sampling nodes and edges in the sampling area.

In some embodiments, a plurality of neural network architectures are randomly sampled in the pre-constructed super network according to a pre-customized importance sampling strategy, and the importance sampling strategy is customized through the following steps:
in architecture sampling, determining a plurality of neural network architectures in the super network by making a decision via an agent, and sampling the plurality of neural network architectures;
obtaining a graph data processing result by processing graph data through the plurality of neural network architectures;
returning a reward value to the agent based on the accuracy of the graph data processing result;
adjusting, based on the reward value, the strategy for a next sampling by the agent; and
obtaining a trained agent by iteratively executing the above steps of making decisions by the agent, processing the graph data, returning the reward value and adjusting the strategy, an architecture sampling strategy executed by the trained agent being the importance sampling strategy.

In some embodiments, the super network includes all graph network layers, each including all information transport methods.

In some embodiments, the architecture training module includes:
a learning team building sub-module, configured to group the plurality of neural network architectures as a learning team;
a classification difficulty value evaluation sub-module, configured to: select an optimal architecture from the learning team, and obtain a classification difficulty value of each of the nodes in the subgraph by evaluating classification difficulty of each of nodes through the optimal architecture;
a weight setting sub-module, configured to set a weight for a loss value of each of the nodes based on the classification difficulty value of each of the nodes; and
a parameter adjustment sub-module, configured to obtain a plurality of trained neural network architectures by adjusting parameters of the plurality of neural network architectures based on the loss value.

In some embodiments, the classification difficulty value evaluation sub-module includes:
a classification result acquisition sub-module, configured to: classify the nodes of the subgraph through each neural network architecture in the plurality of neural network architectures, and obtain node classification results corresponding to the plurality of neural network architectures;
an optimal architecture acquisition sub-module, configured to perform accuracy statistics on the node classification results, and select a neural network architecture corresponding to the node classification result with the highest accuracy as the optimal architecture; and
a classification difficulty value determination sub-module, configured to: obtain a classification difficulty value of each of the nodes in the subgraph by evaluating classification difficulty of each of nodes based on the node classification result corresponding to the optimal architecture.

In some embodiments, the weight setting sub-module includes:
a first loss value weight setting sub-module, configured to set a low weight for the loss value of the node in response to determining that the classification difficulty value of the node is high, and
a second loss value weight setting sub-module, configured to set a high weight for the loss value of the node in response to determining that the classification difficulty value of the node is low.

Based on the same inventive concept, another embodiment of the present application provides a readable storage medium storing a computer program that, when executed by a processor, implements the steps in the architecture search method for a large-scale graph of any of the above embodiments of the present application.

Based on the same inventive concept, another embodiment of the present application provides an electronic device including a memory, a processor, and a computer program stored on the memory and executable by the processor, where the computer program, when executed by the processor, implements the steps in the architecture search method for a large-scale graph of any of the above embodiments of the present application.

With regard to the embodiment of the apparatus, which is substantially similar to the embodiment of the method, the description is relatively brief, and reference is made to the description of the embodiment of the method for associated parts.

In the specification, various embodiments are described in a progressive manner, each of which focuses on differences from the other embodiments, and reference should be made to each other for the same or similar parts.

Those skilled in the art will appreciate that embodiments of the present application can be provided as a method, apparatus, or computer program product. Accordingly, embodiments of the present application may take the form of an entirely hardware embodiment, an entirely software embodiment, or an embodiment combining software and hardware aspects. Furthermore, embodiments of the present application may take the form of a computer program product implemented on one or more computer-usable storage media (including, but not limited to, disk storage, CD-ROM, optical memory, etc.) containing computer-usable program codes therein.

Embodiments of the present application are described with reference to flowcharts and/or block diagrams of methods, terminal devices (systems), and computer program products according to embodiments of the present application. It will be understood that each flow and/or block in the flowcharts and/or block diagrams, and combinations of flows and/or blocks in the flowcharts and/or block diagrams, can be implemented by computer program instructions. These computer program instructions may be provided to a processor of a general-purpose computer, a special-purpose computer, an embedded processor, or other programmable data processing terminal devices to produce a machine, such that the instructions, which execute via the processor of the computer or other programmable data processing terminal devices, create means for implementing the functions specified in a flow or flows of the flowcharts and/or a block or blocks of the block diagrams.

These computer program instructions may also be stored in a computer-readable memory that can direct a computer or other programmable data processing terminal devices to function in a particular manner such that the instructions stored in the computer-readable memory produce an article of manufacture including instruction means that implement the functions specified in a flow or flows of the flowcharts and/or a block or blocks of the block diagrams.

These computer program instructions may also be loaded onto a computer or other programmable data processing terminal devices such that a series of operational steps are performed on the computer or other programmable terminal devices to produce a computer-implemented process such that the instructions which execute on the computer or other programmable terminal devices provide steps for implementing the functions specified in a flow or flows of the flowcharts and/or a block or blocks of the block diagrams.

While preferred embodiments of the present application have been described, additional variations and modifications to these embodiments will occur to those skilled in the art once the basic inventive concepts are known. Therefore, the appended claims are intended to be interpreted as including the preferred embodiments and all such variations and modifications as fall within the scope of the embodiments of the present application.

Finally, it is also noted that relational terms, such as first and second, are used herein solely to distinguish one entity or action from another entity or action without necessarily requiring or implying any actual such relationship or order between such entities or actions. Further, the terms “include”, “comprise”, or any other variation thereof, are intended to encompass a non-exclusive inclusion, such that a process, method, item, or terminal device that includes a list of elements does not include only those elements but may include other elements not expressly listed or inherent to such process, method, item, or terminal device. An element defined by the statement “include a . . . ” does not, without further restrictions, exclude the existence of additional identical elements in the process, method, item, or terminal device that includes the element.

A detailed description has been given to the method and the architecture search apparatus for a large-scale graph, and the device and the storage medium provided by the present application. While principles and implementations of the present application have been illustrated herein in connection with specific examples, the description of above embodiments is intended only to facilitate an understanding of methods and core ideas of the application; meanwhile, those skilled in the art will make variations to the particular implementations and the application scope, according to the ideas of the application. To sum up, the contents of the specification are not construed as limiting the application.

What is claimed is:

1. An architecture search method for a large-scale graph, comprising:
subgraph sampling for obtaining a subgraph of the large-scale graph by performing local sampling on the large-scale graph;
architecture sampling for sampling a plurality of neural network architectures in a pre-constructed super network according to a pre-customized importance sampling strategy;
architecture training for obtaining a plurality of trained neural network architectures by training, according to a peer learning method, the plurality of neural network architectures with the subgraph;
obtaining a trained super network by iteratively executing the subgraph sampling, the architecture sampling, and the architecture training; and
obtaining an optimal architecture corresponding to the large-scale graph by performing architecture search on the trained super network.

2. The architecture search method according to claim 1, wherein the step of obtaining the subgraph of the large-scale graph by performing local sampling on the large-scale graph comprises:
determining a sampling area in the large-scale graph; and
obtaining the subgraph by sampling nodes and edges in the sampling area.

3. The architecture search method according to claim 1, wherein the plurality of neural network architectures are randomly sampled in the pre-constructed super network according to the pre-customized importance sampling strategy, wherein the importance sampling strategy is customized by:
agent decision-making for making, by an agent, a decision to determine the plurality of neural network architectures in the pre-constructed super network in the architecture sampling, and sampling the plurality of neural network architectures;
graph data processing for obtaining a graph data processing result by processing graph data through the plurality of neural network architectures;
reward value returning for returning a reward value to the agent based on an accuracy of the graph data processing result;
strategy adjusting for adjusting, based on the reward value, a strategy for a next sampling by the agent; and
obtaining a trained agent by iteratively executing the agent decision-making, the graph data processing, the reward value returning, and the strategy adjusting, wherein an architecture sampling strategy executed by the agent is the importance sampling strategy.

4. The architecture search method according to claim 1, wherein the super network comprises all graph network layers, each comprising all information transport methods.

5. The architecture search method according to claim 1, wherein the step of obtaining the plurality of trained neural network architectures by training, according to the peer learning method, the plurality of neural network architectures with the subgraph comprises:
grouping the plurality of neural network architectures as a learning team;
selecting an optimal architecture from the learning team, and obtaining a classification difficulty value of each of nodes in the subgraph by evaluating classification difficulty of each of the nodes through the optimal architecture;
setting a weight for a loss value of each of the nodes based on the classification difficulty value of each of the nodes; and
obtaining the plurality of trained neural network architectures by adjusting parameters of the plurality of neural network architectures based on the loss value.

6. The architecture search method according to claim 5, wherein the step of selecting the optimal architecture from the learning team, and obtaining the classification difficulty value of each of the nodes in the subgraph by evaluating classification difficulty of each of the nodes through the optimal architecture, comprises:
obtaining node classification results corresponding to the plurality of neural networks by classifying the nodes of the subgraph through each neural network architecture in the plurality of neural network architectures;
performing accuracy statistics on the node classification results, and selecting a neural network architecture corresponding to a node classification result with a highest accuracy as the optimal architecture; and
obtaining the classification difficulty value of each of the nodes in the subgraph by evaluating classification difficulty of each of the nodes based on the node classification result corresponding to the optimal architecture.

7. The architecture search method according to claim 5, wherein the step of setting the weight for the loss value of each of the nodes based on the classification difficulty value of each of the nodes comprises:
setting a low weight for a loss value of a node in response to determining that the classification difficulty value of the node is high; and
setting a high weight for the loss value of the node in response to determining that the classification difficulty value of the node is low.

8. A computer-readable storage medium storing a computer program, wherein when the computer program is executed by a processor, the computer program allows the processor to execute operations of:
subgraph sampling for obtaining a subgraph of a large-scale graph by performing local sampling on the large-scale graph;
architecture sampling for sampling a plurality of neural network architectures in a pre-constructed super network according to a pre-customized importance sampling strategy;
architecture training for obtaining a plurality of trained neural network architectures by training, according to a peer learning method, the plurality of neural network architectures with the subgraph;
obtaining a trained super network by iteratively executing the subgraph sampling, the architecture sampling, and the architecture training; and
obtaining an optimal architecture corresponding to the large-scale graph by performing architecture search on the trained super network.

9. An electronic device, comprising a memory, a processor, and a computer program, wherein the computer program is stored on the memory and executable by the processor, wherein when the computer program is executed by the processor, the computer program allows the processor to execute operations of:
subgraph sampling for obtaining a subgraph of a large-scale graph by performing local sampling on the large-scale graph;
architecture sampling for sampling a plurality of neural network architectures in a pre-constructed super network according to a pre-customized importance sampling strategy;
architecture training for obtaining a plurality of trained neural network architectures by training, according to a peer learning method, the plurality of neural network architectures with the subgraph;
obtaining a trained super network by iteratively executing the subgraph sampling, the architecture sampling, and the architecture training; and
obtaining an optimal architecture corresponding to the large-scale graph by performing architecture search on the trained super network.

10. The electronic device according to claim 9, wherein the processor is further configured to execute operations of:
determining a sampling area in the large-scale graph; and
obtaining the subgraph by sampling nodes and edges in the sampling area.

11. The electronic device according to claim 9, wherein the plurality of neural network architectures are randomly sampled in the pre-constructed super network according to the pre-customized importance sampling strategy, wherein the importance sampling strategy is customized by:
agent decision-making for making, by an agent, a decision to determine the plurality of neural network architectures in the pre-constructed super network in the architecture sampling, and sampling the plurality of neural network architectures;
graph data processing for obtaining a graph data processing result by processing graph data through the plurality of neural network architectures;
reward value returning for returning a reward value to the agent based on an accuracy of the graph data processing result;
strategy adjusting for adjusting, based on the reward value, a strategy for a next sampling by the agent; and
obtaining a trained agent by iteratively executing the agent decision-making, the graph data processing, the reward value returning, and the strategy adjusting, wherein an architecture sampling strategy executed by the agent is the importance sampling strategy.

12. The electronic device according to claim 9, wherein the super network comprises all graph network layers, each comprising all information transport methods.

13. The electronic device according to claim 9, wherein the processor is further configured to execute operations of:
grouping the plurality of neural network architectures as a learning team;
selecting an optimal architecture from the learning team, and obtaining a classification difficulty value of each of nodes in the subgraph by evaluating classification difficulty of each of the nodes through the optimal architecture;
setting a weight for a loss value of each of the nodes based on the classification difficulty value of each of the nodes; and
obtaining the plurality of trained neural network architectures by adjusting parameters of the plurality of neural network architectures based on the loss value.

14. The electronic device according to claim 13, wherein the processor is further configured to execute operations of:
obtaining node classification results corresponding to the plurality of neural networks by classifying the nodes of the subgraph through each neural network architecture in the plurality of neural network architectures;
performing accuracy statistics on the node classification results, and selecting a neural network architecture corresponding to a node classification result with a highest accuracy as the optimal architecture; and
obtaining the classification difficulty value of each of the nodes in the subgraph by evaluating classification difficulty of each of the nodes based on the node classification result corresponding to the optimal architecture.

15. The electronic device according to claim 13, wherein the processor is further configured to execute operations of:
setting a low weight for a loss value of a node in response to determining that the classification difficulty value of the node is high; and
setting a high weight for the loss value of the node in response to determining that the classification difficulty value of the node is low.
